(19) United States
(12) Patent Application Publication
(10) Pub. No.: US 2002/0009031 A1
(43) Pub. Date: Jan. 24, 2002

(54) Apparatus having a control circuit

(76) Inventors: Horst Rumpf, Herborn (DE); Matthias Kreutz, Eschenburg (DE)

Correspondence Address: Corporate Patent Counsel, U.S. Philips Corporation, Michael E. Marion, 580 White Plains Road, Tarrytown, NY, 10591, US

(21) Appl. No.: 09/854,393

(22) Filed: May 11, 2001

(30) Foreign Application Priority Data
May 16, 2000 (DE) 10023690.1

(51) Int. Cl. G11B 7/00

(52) U.S. Cl. 369/53.18

(57) ABSTRACT

The invention relates to an apparatus having a control circuit which comprises a feedforward filter arrangement (1) and a controller (3). The invention is characterized in that an adaptation of the parameters (P_{ff}) of the feedforward filter arrangement (1) and the parameters (P_{c}) of the controller (3) is effected during operation of the apparatus.

The invention relates to a control circuit having a feed-forward filter arrangement and a controller. Drives for storage disk media (for example CD, DVD, MD) should be insensitive to shocks to a maximal extent. This applies in particular to disk drives for automotive use and to portable apparatuses. In order to avoid breaks as a result of shocks during reading or writing of the storage media use is made of, inter alia, shock attenuation systems. These may be controlled fully electronically or they may operate electromechanically.

An electronically controlled shock attenuation system for a disk drive of the type defined in the opening paragraph is known from EP 0 572 789B1 . By means of an accelerometer it senses the accelerations that occur and it calculates the forces exerted as a result of the acceleration. The accelerometer then supplies an amplified electric signal, which is processed in a control device. This device controls a read unit of the disk drive in such a manner that during reading the read unit is centered with respect to the track to be read from the storage disk medium or deviations from the track to be read are minimized.

It is an object of the present invention to improve the operation of an electronic circuit for vibration compensation in such a disk drive and to provide an improved resistance to shocks.

According to the invention the object is achieved in that an adaptation of the parameters of the feedforward filter arrangement and the parameters of the controller is effected during operation of the apparatus.

In this way it is possible to optimize the response of an electronic circuit for vibration compensation both with regard to different amplitudes and with regard to different frequencies, which each occur depending on the nature of the vibrations. For this purpose, the control circuit is of an adaptive design, as a result of which the parameters of the control circuit are set adapted to the instantaneous vibrations. Moreover, it enables further disturbance variables such as a changed behavior of the read/write head guide mechanism as a result of temperature fluctuations, component tolerances as well as soiled storage disk media to be taken into account as well.

In the embodiment as defined in claim 2 the adaptation algorithm is implemented on a microprocessor. Advantageously, this microprocessor is a digital signal processor (DSP). DSPs are frequently used standard processors, which are cheap and which allow a rapid and parallel processing of a plurality of digital signals. Therefore, the DSP enables a particularly rapid calculation of the parameters of the controller and of the feedforward filters, as a result of which the desired direct adaptation of the parameters to rapidly varying spurious signals is possible.

The embodiment as defined in claim 3 protects disk drives for storage disk media, particularly portable apparatuses and apparatuses for use in cars or other transport means, very effectively against frequently occurring vibrations, because the adaptive control system can more rapidly detect and eliminate external and internal disturbances than conventional systems.

An embodiment of the invention will now be described in more detail by way of example with reference to a FIGURE.

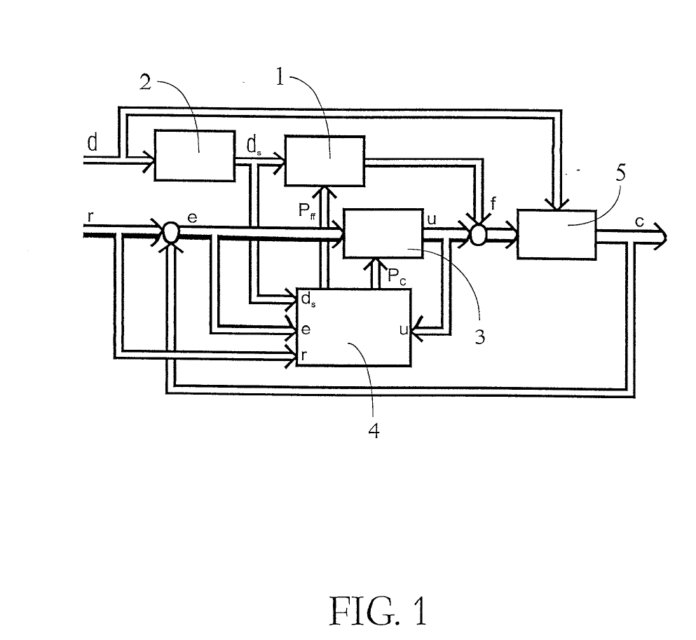

FIG. 1 is a block diagram of a control circuit in an improved electronic circuit for vibration compensation.

In disk drives for storage disk media the data tracks should be scanned with the highest precision in order to enable an error-free reproduction or an error-free recording process to be achieved. Therefore, the purpose of the control circuit in accordance with the invention is to ensure that in a disk drive 5 a scanning element (for example an optical unit), which reads or writes the data tracks of a storage disk medium, follows the data tracks as exactly as possible in its scanning point c, also in the case of vibrations or other deviations. For this purpose, the forces acting on the disk drive 5 are detected via suitable sensors 2. Suitable for this purpose are, inter alia, piezoelectric acceleration sensors capable of detecting three-dimensionally acting acceleration forces. The sensors 2 convert the acceleration forces detected as disturbance signals d into electric disturbance signals dₛ, which can be processed in the control circuit. The electric disturbance signals dₛ are applied to a so-called feedforward filter arrangement 1 and at the same time serve as an input signal for a digital signal processor (DSP) 4. For the definition of a feedforward filter reference is made to a contribution by Philips to the SAE conference paper No. 981152 (SAE International Congress and Exposition in Detroit, Mich. Feb. 23-26 1998), which describes how a feedforward filter operates. The feedforward filter arrangement transfers an output signal to the disk drive 5 as disturbance-variable feedforward f, the disk drive 5 now corresponding to the controlled system in a control loop. Further inputs of the DSP 4 receive reference variables r, the deviations that occur in the control process in the form of error signals e and control variables u. The outputs of the DSP 4 now adapt, on the one hand, the parameters P_{ff} of the feedforward filter arrangement 1 and, on the other hand, the parameters P_{c} of a controller 3. For an optimum scanning process in the disk drive 5 the controller 3 should control the system so as to minimize the error signals e. This achieved by means of an adaptation of the parameters P_{ff} of the feedforward filter arrangement 1 and the parameters P_{c} of the controller 3, in addition to the disturbance-variahle feedforward f. In order to enable this adaptation to be made a so-called adaptation algorithm is executed on the DSP, which algorithm calculates the optimum parameters P_{c} and P_{ff} from the reference variables r, the error signals e, the disturbance signals dₛ and the control variables u. In this way, the controller 3 and the feedforward filter arrangement 1 can be controlled so as to respond to different external effects, such as brief impacts, shocks, sustained vibrations and component variations in the disk drive 5 as a result of temperature fluctuations, with appropriately adapted control and filter characteristics. Obviously, the same approach also applies to the occurrence of internal disturbances such as component tolerances, offsets, temperature and lifetime dependent parameters and soiled storage disk media.

As a result of the adaptive control behavior no compromises are necessary in the design of the controller 3 and the feedforward filter arrangement 1, which facilitates the accurate maintenance of the scanning pint c and thus improves the scanning accuracy. This is particularly important for drives in which DVDs are scanned. Since in this case the individual bits of the data tracks have a much higher density than on CDs, they basically require a particularly precise read/write device because otherwise even slight vibrations or other fluctuations in the disk drive 5 could give rise to errors.

In spite of the distinctly improved immunity to disturbances as a result of the electronic circuit for vibration compensation it may be useful to provide an additional memory device from which the data read from the storage disk medium, particularly in the case of DVDs, can more rapidly as be read and retrieved well as buffered for a given time and subsequently be retrieved. Thus,there is always a buffer as a result of which the reproduction will not falter even in the case of a disturbance outside the control range, such as for example a heavy blow on the housing of such a disk drive 5.

1. An apparatus having a control circuit which comprises a feedforward filter arrangement (1) and a controller (3), characterized in that an adaptation of the parameters (P_{ff}) of the feedforward filter arrangement (1) and the parameters (P_{c}) of the controller (3) is effected during operation of the apparatus.

2. An apparatus as claimed in claim 1, characterized in that for the adaptation an adaptation algorithm is executed on a microprocessor (4), particularly a digital signal processor (4).

3. An apparatus as claimed in claim 1 or 2, characterized in that said apparatus includes a disk drive (5) for storage disk media, in which vibrations and internal disturbances which occur during operation of the apparatus are compensated by an adaptation of the parameters (P_{ff}) of the feedforward filter arrangement (1) and the parameters (P_{c}) of the controller (3).
